(19) United States
(12) Patent Application Publication
(10) Pub. No.: US 2024/0212030 A1
(43) Pub. Date: Jun. 27, 2024

(54) DISPLAY DEVICE, DISPLAY METHOD, AND RECORDING MEDIUM

(71) Applicant: NEC Corporation, Tokyo (JP)

(72) Inventors: Takeshi YOSHIDA, Tokyo (JP); Katsufumi Tanaka, Tokyo (JP)

(73) Assignee: NEC Corporation, Tokyo (JP)

(21) Appl. No.: 18/544,846

(22) Filed: Dec. 19, 2023

(30) Foreign Application Priority Data
Dec. 27, 2022 (JP) 2022-209201

(51) Int. Cl. G06Q 30/0601; G06F 3/0482; G06F 3/0483

(52) U.S. Cl. CPC G06Q 30/0641; G06F 3/0482; G06F 3/0483; G06Q 30/0631

(57) ABSTRACT

A display device of the present disclosure includes acquisition means that acquires product information for specifying an ordered product ordered by a user from products on a digital catalog, extraction means that extracts a plurality of ordered product candidates associated with the product information from the products on the digital catalog, and display means that displays a screen for allowing the user to select the ordered product from the plurality of extracted ordered product candidates.

This application is based upon and claims the benefit of priority from Japanese Patent Application No. 2022-209201, filed on Dec. 27, 2022, the disclosure of which is incorporated herein in its entirety by reference.

### TECHNICAL FIELD

The present disclosure relates to a display device, a display method, a recording medium, and the like.

### BACKGROUND ART

In home delivery businesses of foodstuffs and daily necessities, users who order products using the Internet are increasing. Therefore, there is a technology for helping users to find products to order from products posted on the Internet.

For example, PTL 1 (JP 2019-087275 A) discloses that a page on which a product related to input information of voice uttered by a user is posted is output to a user terminal from pages on which a large number of pieces of product information are posted.

### SUMMARY

An example of an object of the present disclosure is to provide a display device that allows a user to easily select an ordered product even when a plurality of products is applicable by search.

A display device in one aspect of the present disclosure includes acquisition means that acquires product information for specifying an ordered product ordered by a user from products on a digital catalog, extraction means that extracts a plurality of ordered product candidates associated with the product information from the products on the digital catalog, and display means that displays a screen for allowing the user to select the ordered product from the plurality of extracted ordered product candidates.

In a display method in one aspect of the present disclosure, a computer acquires product information for specifying an ordered product ordered by a user from products on a digital catalog, extracts a plurality of ordered product candidates associated with the product information from the products on the digital catalog, and displays a screen for allowing the user to select the ordered product from the plurality of extracted ordered product candidates.

A non-transitory computer-readable recording medium in one aspect of the present disclosure records a program for causing a computer to execute acquiring product information for specifying an ordered product ordered by a user from products on a digital catalog, extracting a plurality of ordered product candidates associated with the product information from the products on the digital catalog, and displaying a screen for allowing the user to select the ordered product from the plurality of extracted ordered product candidates.

### BRIEF DESCRIPTION OF THE DRAWINGS

Exemplary features and advantages of the present disclosure will become apparent from the following detailed description when taken with the accompanying drawings in which:

FIG. 1 is a block diagram illustrating a configuration including a display device in a present disclosure;

FIG. 2 is a diagram illustrating a hardware configuration in which the display device in the present disclosure is achieved by a computer device and its peripheral device;

FIG. 3 is an example of a screen on which ordered product candidates are output in the present disclosure;

FIG. 4 is another example of a screen on which ordered product candidates are output in the present disclosure;

FIG. 5 is another example of a screen on which ordered product candidates are output in the present disclosure;

FIG. 6 is a block diagram illustrating a configuration including a display device in a modification of the present disclosure;

FIG. 7 is a flowchart illustrating an operation of a display method in the modification of the present disclosure;

FIG. 8 is a block diagram illustrating a configuration including a display device in the present disclosure;

FIG. 9 is a display example of a screen that accepts limited product information in the present disclosure; and

FIG. 10 is a flowchart illustrating an operation of a display method in the present disclosure.

### EXAMPLE EMBODIMENT

Next, example embodiments will be described in detail with reference to the drawings.

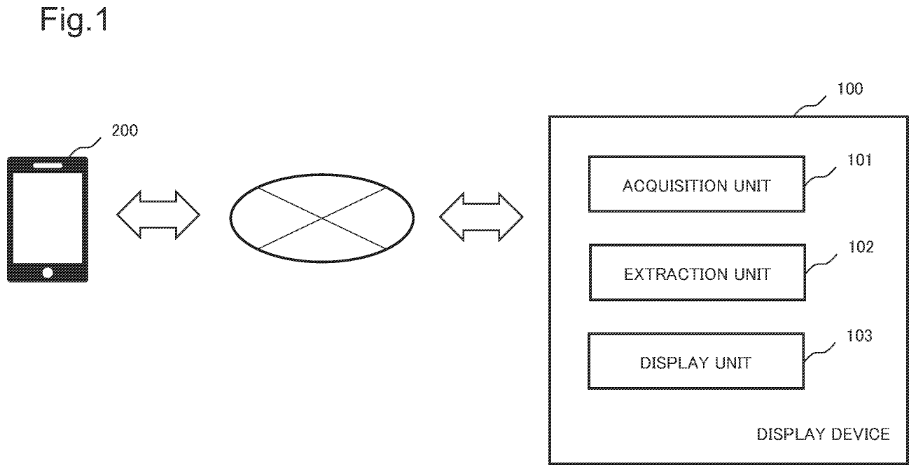

FIG. 1 is a block diagram illustrating a configuration of a display device 100 in a present disclosure. The display device 100 can transmit, through a network, a digital catalog on which a product ordered by a user is posted to a user terminal 200 such as a personal computer (PC) or a smartphone. In the user terminal 200, for example, an application program for using a product home delivery service may be installed in advance. The user terminal 200 includes a voice input device such as a microphone, and transmits product information necessary for specifying a product to be ordered to the display device 100 via the application program. The display device 100 acquires the product information input to the application program through a communication interface 508 described later.

The product home delivery service in the present disclosure is, for example, a service in which home delivery of a product ordered in advance can be periodically received on a predetermined day of the week such as once a week. Next, a configuration of the display device 100 in the present disclosure will be described in detail. Referring to FIG. 1, the display device 100 includes an acquisition unit 101, an extraction unit 102, and a display unit 103.

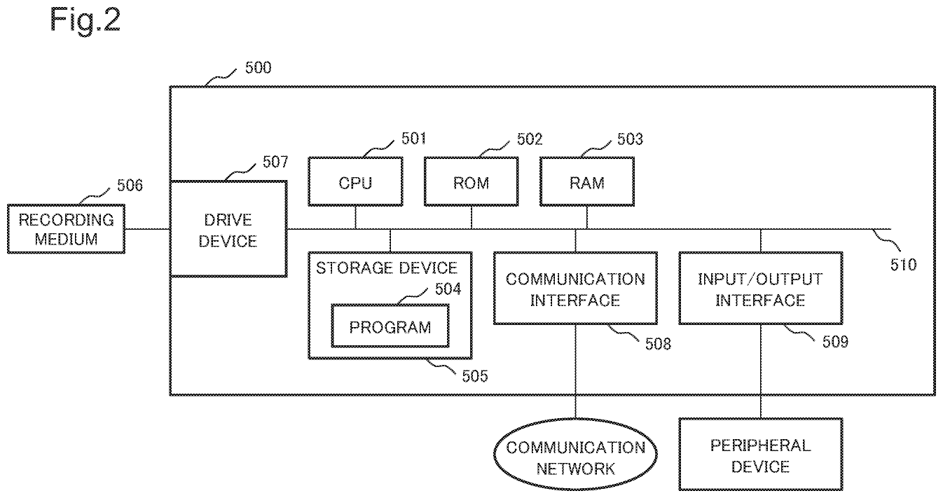

FIG. 2 is a diagram illustrating an example of a hardware configuration in which the display device 100 in the present disclosure is achieved by a computer device 500 including a processor. As illustrated in FIG. 2, the display device 100 includes a memory such as a central processing unit (CPU) 501, a read only memory (ROM) 502, and a random access memory (RAM) 503, a storage device 505 such as a hard disk that stores a program 504, the communication interface 508 for network connection, and an input/output interface 509 that inputs and outputs data. In the present disclosure, the components in the display device 100 are connected to each other via, for example, a bus 510. The display device 100 in the present disclosure illustrated in FIG. 1 can also be configured by cloud computing or the like.

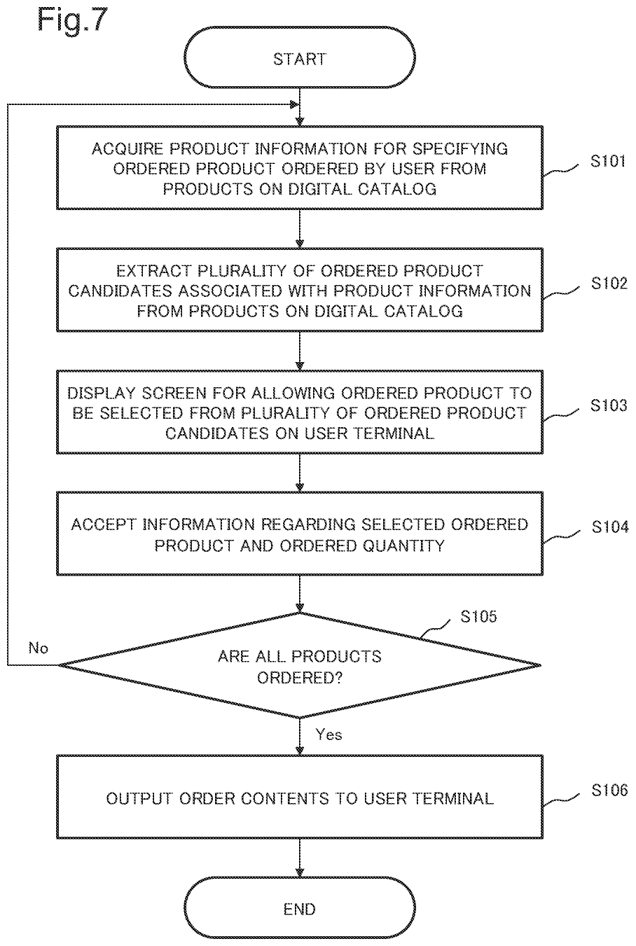

The CPU 501 operates an operating system and controls the entire display device 100 according to the present disclosure. The CPU 501 reads a program and data from, for example, a recording medium 506 mounted on a drive device 507 or the like to the memory. The CPU 501 functions as the acquisition unit 101, the extraction unit 102, the display unit 103, and a part of these in the present disclosure, and executes processing or a command in a flowchart illustrated in FIG. 7 to be described later based on a program.

The recording medium 506 is, for example, an optical disk, a flexible disk, a magneto-optical disk, an external hard disk, a semiconductor memory, or the like. The semiconductor memory or the like that is a part of the recording medium is a non-volatile storage device, and records a program. The program may be downloaded from an external computer (not illustrated) connected to a communication network.

As described above, the present disclosure illustrated in FIG. 1 is achieved by computer hardware illustrated in FIG. 2. Means to achieve each unit included in the display device 100 in FIG. 1 is not limited to the configuration described above. The display device 100 may be achieved by one physically coupled device, or may be achieved by a plurality of devices by connecting equal to or more than two physically separated devices in a wired or wireless manner.

The acquisition unit 101 is acquisition means that acquires product information for specifying an ordered product ordered by a user from products on a digital catalog. The acquisition unit 101 acquires product information in characters, images, voice, or the like from the user terminal 200 through the network. The product information is information for specifying a product such as a product name, a product number, a product category, and a product image. In the present example embodiment, the product category may be a large classification such as vegetables, meats, confectioneries, frozen foods, fresh foods, seasonings, and the like. The product category may be a small classification such as potato chips or curry roux. The acquisition unit 101 outputs the acquired product information to the extraction unit 102.

The extraction unit 102 is means that extracts a plurality of ordered product candidates associated with product information from products on a digital catalog. When the product information is input from the acquisition unit 101, the extraction unit 102 performs search using the input product information as a search word, and extracts a product or a category including the search word among the products on the digital catalog. The extraction unit 102 may extract a product or a category that match at least a part of the search word. In a case where image data is input as the product information from the acquisition unit 101, the extraction unit 102 extracts a product having the same or similar appearance as that in the image. In a case where there are equal to or more than a predetermined number of types of ordered product candidates, the extraction unit 102 may extract recommended products as the ordered product candidates. The recommended products are products that are in stock equal to or more than a predetermined number in a store, seasonal products, or the like. When the ordered product candidates are extracted, the extraction unit 102 outputs information regarding the extracted ordered product candidates to the display unit 103.

The display unit 103 is means that displays a screen for allowing a user to select an ordered product from a plurality of extracted ordered product candidates. In the present example embodiment, when information regarding the ordered product candidates extracted from the extraction unit 102 is input, the display unit 103 displays the plurality of ordered product candidates on the screen in a mode selectable by the user. The selectable mode is, for example, that the user can select the product to order by touching an image of an ordered product candidate or inputting a product name or a product number of the ordered product candidate by voice in a state where the screen is displayed.

The display unit 103 may display the ordered product candidates in order determined based on a purchase history of the user. For example, the display unit 103 displays the ordered product candidates in such a way that an ordered product candidate matching a characteristic of a product such as a production area of the product or a capacity of the product purchased by the user in the past is displayed first. The display unit 103 may also estimate a product to be purchased by the user based on a family structure or the purchase history of the user, and display the ordered product candidates in such a way that the estimated product is displayed first as the ordered product candidate.

The display unit 103 may further output information regarding an order content for the plurality of ordered product candidates on the screen by display or voice. The information regarding the order content is information based on the purchase history such as the number of purchases or the latest purchase date of the user of the same or an associated product, information based on a purchase status of another user of the product, or the like. For example, in a case where the user has purchased the same or an associated product within a predetermined period, the display unit 103 may output information that calls attention to the redundant purchase on the screen by display or voice. The display unit 103 may also output information that recommends purchase of a periodically purchased product on the screen by display or voice.

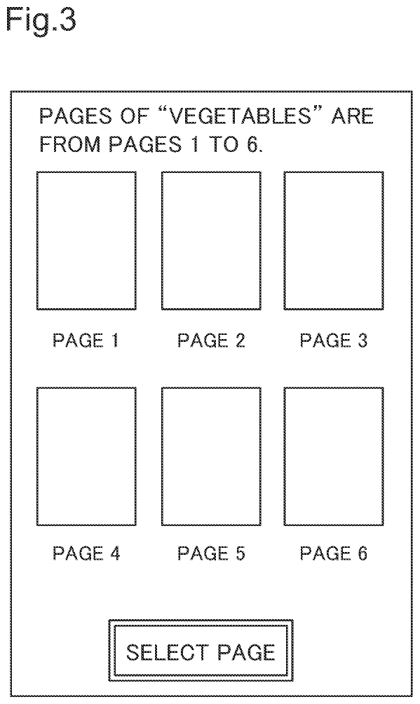

FIG. 3 is an example of a screen on which ordered product candidates are output in the present disclosure. The example of the screen of FIG. 3 is an example of a case where a plurality of ordered product candidates is posted on a plurality of pages on a digital catalog. As illustrated in FIG. 3, for example, the display unit 103 reduces and displays the plurality of pages related to the plurality of ordered product candidates on the user terminal 200. Each square illustrated in FIG. 3 indicates a state where each page of the digital catalog, on which products related to vegetables are posted, is reduced and displayed. The example of the screen of FIG. 3 is a screen for allowing one of the plurality of pages related to the extracted ordered product candidates to be selected when a user inputs “vegetable” as product information, and for example, one of the pages can be selected by touching each page on the screen. The display unit 103 may also display information regarding the number of pages of the extracted plurality of pages. In the example of the screen of FIG. 3, it is indicated that there are pages 1 to 6. The display unit 103 may highlight a page selected by the user by surrounding the page with a thick line, or the like.

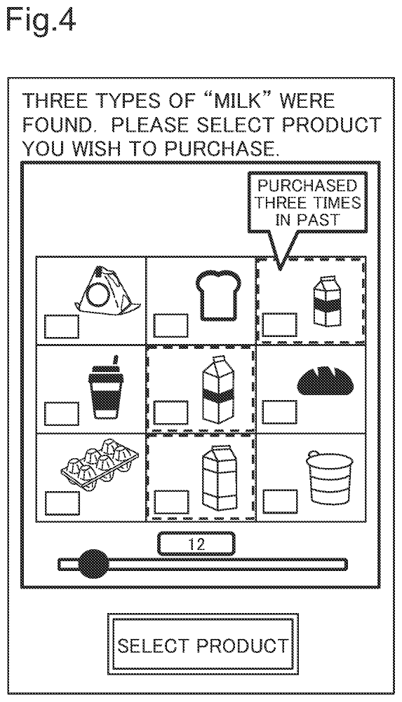

FIG. 4 is an example of another screen on which ordered product candidates are output in the present disclosure. The example of the screen of FIG. 4 is an example of a case where a plurality of ordered product candidates is posted on the same page. As illustrated in FIG. 4, for example, the display unit 103 displays the page related to the plurality of ordered product candidates on the user terminal 200, and highlights a plurality of ordered product candidates. The example of the screen of FIG. 4 is a screen for allowing one of the extracted ordered product candidates to be selected when a user inputs “milk” as product information. As illustrated in FIG. 4, three types of “milk” are posted on page 12 of a digital catalog, and each of the types is surrounded by a square. On the screen of FIG. 4, it is possible to select each ordered product candidate by touching the ordered product candidate on the screen. In the screen of FIG. 4, the display unit 103 displays information based on a history of purchase in the past for one of the plurality of ordered product candidates. When an ordered product candidate is selected by the user, the display unit 103 may switch the display in such a way as to highlight only the selected ordered product candidate.

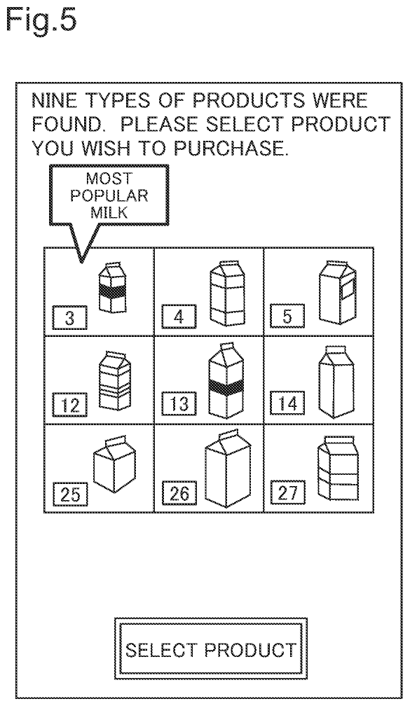

FIG. 5 is an example of another screen on which ordered product candidates are output in the present disclosure. The example of FIG. 5 is an example of a case where a plurality of ordered product candidates is scattered and posted on a digital catalog. The case of being scattered and posted refers to a case where the plurality of ordered product candidates is posted on the digital catalog in order in which at least some of the ordered product candidates are not adjacent to each other.

As illustrated in FIG. 5, for example, the display unit 103 cuts out portions where information regarding the ordered product candidates on the digital catalog is posted and displays a list of the cut out portions on the user terminal 200. The example of the screen of FIG. 5 is a screen for allowing one of the extracted ordered product candidates to be selected when a user inputs “milk” as product information, and the portions where “milk” is posted are cut out from the digital catalog and displayed in the list. On the screen of FIG. 5, it is possible to select each ordered product candidate by touching each ordered product candidate on the screen. In the screen of FIG. 5, the display unit 103 displays that one of the plurality of ordered product candidates has a purchase history by another user a predetermined number of times and is a popular product. When an ordered product candidate is selected by the user, the display unit 103 may switch the display in such a way as to highlight only the selected ordered product candidate.

In the display device 100, the display unit 103 displays a screen for allowing an ordered product to be selected from a plurality of ordered product candidates on the user terminal 200. With this configuration, even when a plurality of products associated with product information input by a user is extracted on the digital catalog, the user can easily select the ordered product.

### Modification of First Example Embodiment

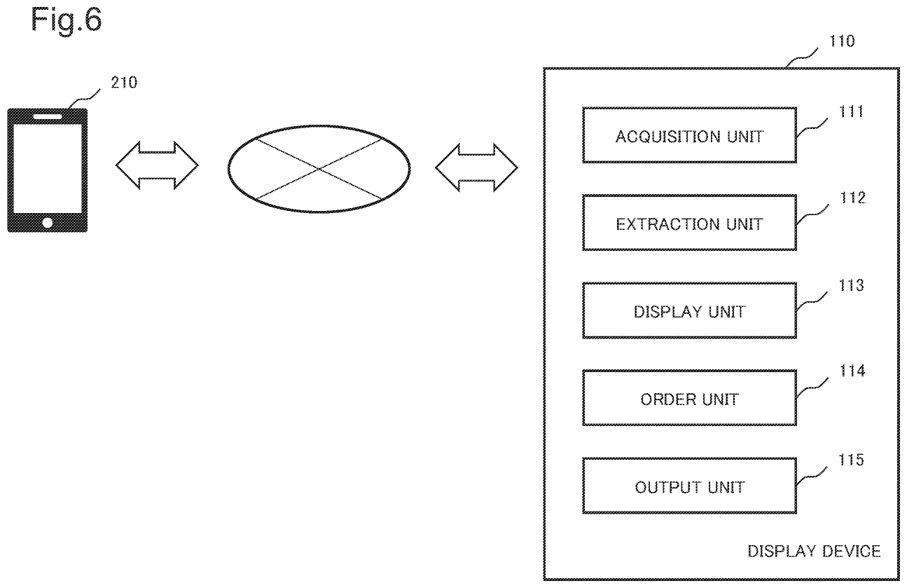

FIG. 6 is a block diagram illustrating a configuration of a display device 110 in a modification of the present disclosure. In the modification of the present disclosure, a configuration from display of a plurality of extracted ordered product candidates on a screen in a mode selectable by a user to completion of ordering of a product by the user in the configuration of the present disclosure will be described. Referring to FIG. 6, the display device 110 includes an acquisition unit 111, an extraction unit 112, a display unit 113, an order unit 114, and an output unit 115. Configurations of the acquisition unit 111, the extraction unit 112, and the display unit 113 are similar to the configurations of the acquisition unit 101, the extraction unit 102, and the display unit 103 in the present disclosure.

The order unit 114 is means that accepts an ordered product and an ordered quantity selected on a screen. The order unit 114 accepts information regarding an ordered product selected by a user from a plurality of ordered product candidates displayed on the screen. Next, when the information regarding the ordered product is accepted, the order unit 114 accepts an ordered quantity of the ordered product. The order unit 114 may accept the ordered quantity by an input of a number on an order screen, or may accept the ordered quantity by voice. When all ordered products and ordered quantities of the ordered products are accepted, the order unit 114 outputs order contents to the output unit 115. For example, when a pressing operation on an order confirmation button in the order screen is detected, the order unit 114 outputs all the order contents to the output unit 115.

The output unit 115 is means that outputs an accepted order content. When order contents of all ordered products are input from the order unit 114, for example, the output unit 115 outputs the accepted order contents to a user terminal 210 of a user through a network. The output unit 115 may output the order contents by voice from a speaker of the user terminal 210 or may display a list of the order contents on a display of the user terminal 210.

The order unit 114 may also accept modification of the order contents. The order unit 114 accepts deletion of an ordered product or addition of an ordered product by an operation or voice input on a screen displaying the list of the order contents. When accepting deletion of an ordered product or addition of an ordered product, the output unit 115 may update and output the order contents.

The operation of the display device 110 configured as described above will be described with reference to a flowchart of FIG. 7.

FIG. 7 is a flowchart illustrating an outline of the operation of the display device 110 in the modification of the present disclosure. Processing according to this flowchart may be executed based on program control by the processor described above. In the present example embodiment, steps S101 to S103 are a flow in a case of the minimum configuration.

As illustrated in FIG. 7, first, the acquisition unit 111 acquires product information for specifying an ordered product ordered by a user from products on a digital catalog (step S101). Next, the extraction unit 112 extracts a plurality of ordered product candidates associated with the product information from the products on the digital catalog (step S102). Next, the display unit 113 displays a screen for allowing the ordered product to be selected from the plurality of ordered product candidates on the user terminal 210 (step S103). Next, the order unit 114 accepts information regarding the selected ordered product and an ordered quantity (step S104). The display device 110 repeats the flow of S101 to S104 until information regarding all ordered products and ordered quantities are accepted (step S105). Finally, the output unit 115 outputs accepted order contents to the user terminal 210 (step S106). Thus, the display device 110 ends the operation.

In the present modification, in a case where acquisition of product information, acceptance of information regarding ordered products and ordered quantities, and output of order contents are performed by voice via a microphone or the speaker of the user terminal 210 in the display device 110, there is no need to perform an operation on a screen of an application program. Therefore, even a user who is not accustomed to the operation of the terminal can easily use the Internet order.

### Second Example Embodiment

Next, a second example embodiment of the present disclosure will be described in detail with reference to the drawings. Hereinafter, description of contents overlapping with the above description will be omitted to the extent that the description of the present example embodiment is not unclear. Similarly to the computer device illustrated in FIG. 2, a function of each component in each example embodiment of the present disclosure can be achieved not only by hardware but also by a computer device or software based on program control.

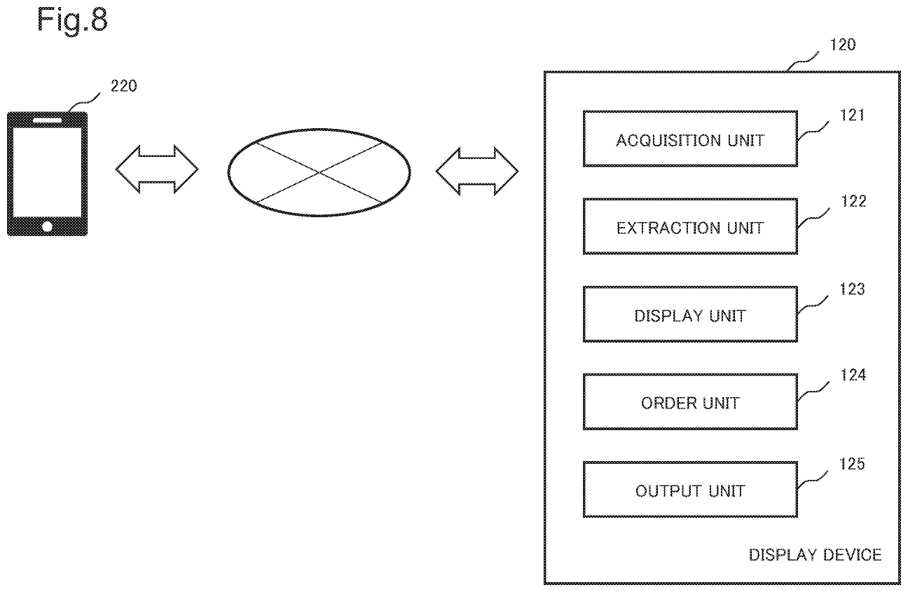

FIG. 8 is a block diagram illustrating a configuration of a display device 120 according to the present disclosure. With reference to FIG. 8, the display device 120 according to the present disclosure will be described focusing on a portion different from the display device 100 according to the present disclosure. Referring to FIG. 8 according to the present disclosure, the display device 120 includes an acquisition unit 121, an extraction unit 122, a display unit 123, an order unit 124, and an output unit 125. The second example embodiment assumes a case where there are equal to or more than a predetermined number of types of a plurality of ordered product candidates extracted by the extraction unit 122. Examples of the case where there are equal to or more than a predetermined number of types include a case where there are so many types of ordered product candidates that all ordered product candidates cannot be displayed on one screen.

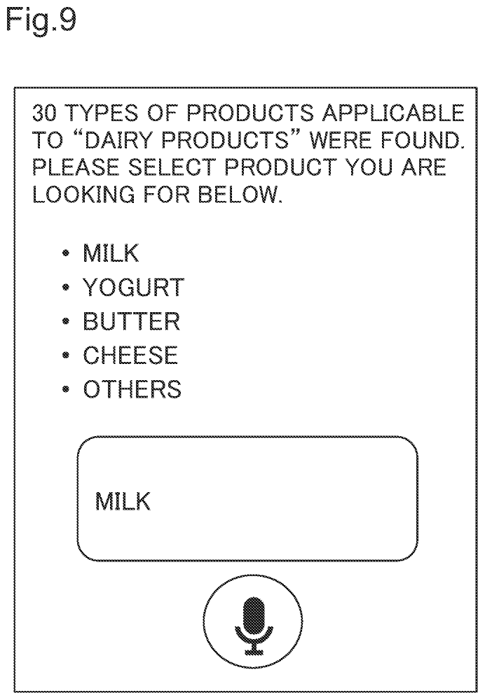

In the second example embodiment, in a case where there are equal to or more than a predetermined number of types of a plurality of ordered product candidates, the display unit 123 displays a screen that accepts limited product information for limiting the plurality of ordered product candidates, in addition to the operation of the display unit 103 in the present disclosure. FIG. 9 is a display example of the screen that accepts the limited product information. In the example of FIG. 9, there are equal to or more than a predetermined number of types (30 types) of products applicable to “dairy products”, and the limited product information is selected in order to reduce the number of types of ordered product candidates. The example of FIG. 9 also illustrates that the limited product information is accepted by voice input, and “milk” is selected.

The acquisition unit 121 acquires limited product information input to a user terminal 220, in addition to the operation of the acquisition unit 101 in the present disclosure. The acquisition unit 121 acquires the limited product information in characters, an image, or voice input. As the limited product information, a category name that is a smaller classification than product information, information indicating whether a product is a special product such as a campaign product or a standard product, or the like is exemplified.

The extraction unit 122 extracts a plurality of ordered product candidates associated with limited product information on a digital catalog, in addition to the operation of the extraction unit 102 in the present disclosure. When the limited product information is input from the acquisition unit 121, the extraction unit 122 performs search using the input limited product information as a search word, and extracts a product including the search word or a product included in a category among products on the digital catalog.

The display unit 123 further displays information regarding the extracted products. In a case where there is a plurality of types of extracted products (ordered product candidates), the display unit 123 may display a screen for allowing an ordered product to be selected from the plurality of ordered product candidates. In the present disclosure, the order unit 124 and the output unit 125 are not essential configurations, and the configurations of the order unit 124 and the output unit 125 are similar to the configurations of the order unit 114 and the output unit 115 in the modification of the present disclosure.

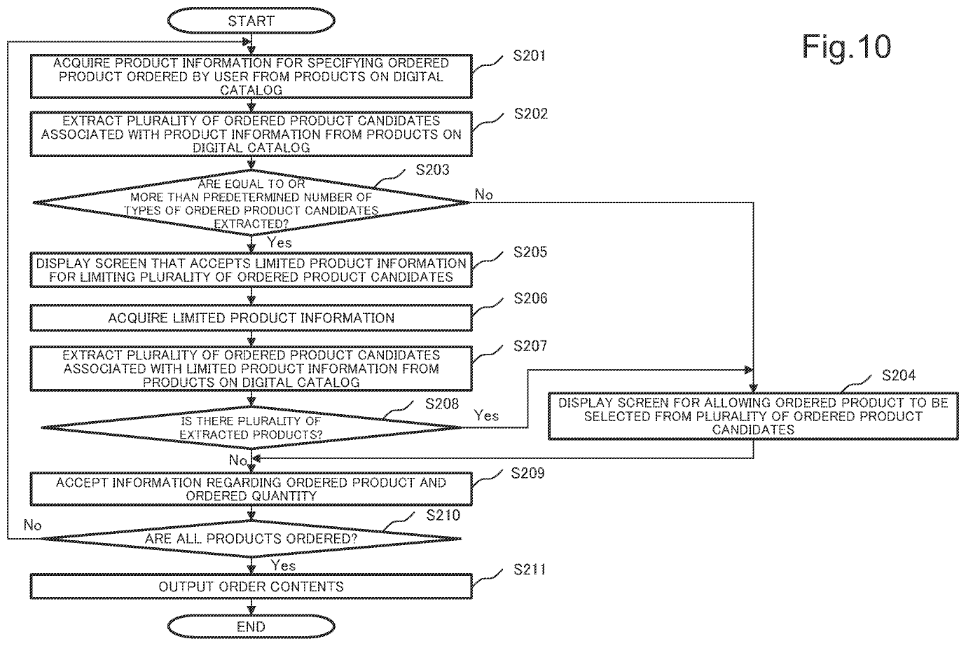

Next, the operation of the display device 120 will be described with reference to a flowchart illustrated in FIG. 10. Processing according to this flowchart may also be executed based on program control by the CPU described above.

As illustrated in FIG. 10, first, the acquisition unit 121 acquires product information for specifying an ordered product ordered by a user from products on a digital catalog (step S201). Next, the extraction unit 122 extracts a plurality of ordered product candidates associated with the product information from the products on the digital catalog (step S202). In a case where there are not equal to or more than a predetermined number of types of the plurality of extracted ordered product candidates (S203; NO), the display unit 123 displays a screen for allowing the ordered product to be selected from the plurality of ordered product candidates (step S204), and the flow proceeds to S209.

On the other hand, in a case where there are equal to or more than a predetermined number of types of the plurality of extracted ordered product candidates (step S203; YES), the display unit 123 displays a screen that accepts limited product information for limiting the plurality of ordered product candidates (step S205), the acquisition unit 121 acquires the limited product information (step S206), and the extraction unit 122 extracts a plurality of ordered product candidates associated with the limited product information from the products on the digital catalog (step S207). In a case where there is not the plurality of extracted products in step S207 (S208; NO), the flow proceeds to S209. On the other hand, in a case where there is the plurality of extracted products in step S207 (S208; YES), the display unit 123 displays a screen for allowing the ordered product to be selected from the plurality of ordered product candidates (step S204), and the flow proceeds to S209.

Next, the order unit 124 accepts information regarding the selected ordered product and an ordered quantity (step S209). The display device 120 repeats the flow of S201 to S209 until information regarding all ordered products and ordered quantities are accepted (step S210). Finally, the output unit 125 outputs accepted order contents to the user terminal 220 (step S211). Thus, the display device 120 ends the operation.

In the display device 120 in the present disclosure, in a case where there are equal to or more than a predetermined number of types of a plurality of extracted ordered product candidates, the display unit 123 displays a screen that accepts limited product information for limiting the plurality of ordered product candidates. As a result, the number of types of ordered product candidates to be extracted is further reduced. Therefore, a user can easily find a product to order.

While the present disclosure has been particularly shown and described with reference to exemplary embodiments thereof, the present disclosure is not limited to these embodiments. It will be understood by those of ordinary skill in the art that various changes in form and details may be made therein without departing from the spirit and scope of the present disclosure as defined by the claims.

For example, although the plurality of operations is described in order in the form of the flowchart, the order of description does not limit the order of execution of the plurality of operations. Therefore, when each exemplary embodiment is implemented, the order of the plurality of operations can be changed within a range that does not interfere in content.

The previous description of embodiments is provided to enable a person skilled in the art to make and use the present disclosure. Moreover, various modifications to these example embodiments will be readily apparent to those skilled in the art, and the generic principles and specific examples defined herein may be applied to other embodiments without the use of inventive faculty. Therefore, the present disclosure is not intended to be limited to the example embodiments described herein but is to be accorded the widest scope as defined by the limitations of the claims and equivalents. Further, it is noted that the inventor's intent is to retain all equivalents of the claimed invention even if the claims are amended during prosecution.

In the invention described in JP 2019-087275 A described above, there is a case where a plurality of products related to input information of voice uttered by a user is applicable. In this case, there is a demand for a mechanism that enables a user to easily find an ordered product ordered by the user.

An example of an effect according to the present disclosure is to provide a display device that allows a user to easily select an ordered product even when a plurality of products is applicable by search.

What is claimed is:

1. A display device comprising:
a memory storing instructions; and
at least one processor configured to execute the instructions to:
acquire product information for specifying an ordered product ordered by a user from products on a digital catalog;
extract a plurality of ordered product candidates associated with the product information from the products on the digital catalog; and
display a screen for allowing the user to select the ordered product from the plurality of extracted ordered product candidates.

2. The display device according to claim 1, wherein the at least one processor is further configured to execute the instructions to:
in a case where the plurality of ordered product candidates is posted on a plurality of pages on the digital catalog, reduce and display the plurality of pages related to the plurality of ordered product candidates on the screen; and
display each of the plurality of pages in such a way as to be selectable.

3. The display device according to claim 1, wherein the at least one processor is further configured to execute the instructions to:
in a case where the plurality of ordered product candidates is posted on the same page on the digital catalog, display the page on the screen; and
display the plurality of ordered product candidates in such a way that each of the ordered product candidates is highlighted and selectable.

4. The display device according to claim 1, wherein the at least one processor is further configured to execute the instructions to:
in a case where the plurality of ordered product candidates is scattered and posted on the digital catalog, cut out portions where the ordered product candidates are posted and display a list of the cut out portions; and
display each of the plurality of ordered product candidates in such a way as to be selectable.

5. The display device according to claim 1, wherein the at least one processor is further configured to execute the instructions to:
output information regarding an order content of at least one of the plurality of ordered product candidates on the screen by display or voice.

6. The display device according to claim 1, wherein the at least one processor is further configured to execute the instructions to:
accept information regarding the selected ordered product and an ordered quantity; and
output an accepted order content.

7. The display device according to claim 1, wherein the at least one processor is further configured to execute the instructions to:
extract a recommended product among the plurality of ordered product candidates in a case where there are equal to or more than a predetermined number of types of the plurality of ordered product candidates.

8. The display device according to claim 1, wherein the at least one processor is further configured to execute the instructions to:
display a screen that accepts limited product information for limiting the plurality of ordered product candidates in a case where there are equal to or more than a predetermined number of types of the plurality of ordered product candidates;
acquire the limited product information;
extract a product associated with the limited product information on the digital catalog; and
display information regarding the extracted product.

9. A display method by a computer, the display method comprising:
acquiring product information for specifying an ordered product ordered by a user from products on a digital catalog;
extracting a plurality of ordered product candidates associated with the product information from the products on the digital catalog; and
displaying a screen for allowing the user to select the ordered product from the plurality of extracted ordered product candidates.

10. A non-transitory computer-readable recording medium that records a program for causing a computer to execute:
acquiring product information for specifying an ordered product ordered by a user from products on a digital catalog;
extracting a plurality of ordered product candidates associated with the product information from the products on the digital catalog; and
displaying a screen for allowing the user to select the ordered product from the plurality of extracted ordered product candidates.
